(19) United States
(12) Patent Application Publication
(10) Pub. No.: US 2021/0213734 A1
(43) Pub. Date: Jul. 15, 2021

(54) PRINTER SERVICE STATION

(71) Applicant: HEWLETT-PACKARD DEVELOPMENT COMPANY, L.P., Spring, TX (US)

(72) Inventors: Warren Scott MARTIN, Vancouver, WA (US); Miguel ALVAREZ, Vancouver, WA (US); Michael GRAHAM, Vancouver, WA (US)

(73) Assignee: HEWLETT-PACKARD DEVELOPMENT COMPANY, L.P., Houston, TX (US)

(21) Appl. No.: 16/075,917

(22) PCT Filed: Apr. 21, 2017
(86) PCT No.: PCT/US2017/028872

§ 371 Date: Aug. 6, 2018

(51) Int. Cl. B41J 2/125; B29C 64/112; B29C 64/393

(52) U.S. Cl. CPC B41J 2/125; B29C 64/393; B29C 64/112

(57) ABSTRACT

A printer and method for ejecting fluid through nozzles of the printer to a surface of a service station of the printer to perform drop detection of the nozzles. A rotation device of the service station turns the surface.

### BACKGROUND

Printers may eject liquid through nozzles for printing with the fluid to give a printed product. Some printers may apply light or heat to the ejected fluid for the printing. Printers may also include a service station to service or maintain the nozzles.

### BRIEF DESCRIPTION OF THE DRAWINGS

Certain examples are described in the following detailed description and in reference to the drawings, in which:

FIGS. 1-2 are diagrams of printers in accordance with examples;

FIGS. 3-4 are block flow diagrams of respective methods of operating a printer in accordance with examples.

FIGS. 5-8A are diagrams of a service station of a printer in accordance with examples; and

FIG. 9 is a block diagram of a computer-readable medium that may contain code to execute operate aspects of a service station of a printer in accordance with examples.

### DETAILED DESCRIPTION OF SPECIFIC EXAMPLES

Printer nozzle functioning can impact print quality. Servicing, testing, and maintaining the print nozzles via a service station can contaminate the service station with residual fluid, powder, ink, and the like. Some examples herein are directed to a printer service station and associated testing of print nozzles.

One example includes a printer having print nozzles and a service station. The service station includes a surface in a first position to receive spit fluid ejected from the print nozzles for drop detection. The service station includes a drop detector to sense the spit fluid ejected from the print nozzles to the surface in the first position. Further, the service station includes a rotation device to turn the surface from the first position to a second position in which the service station does not perform the drop detection.

Certain examples are directed to a printer and a service station of a printer. The printer may be a two-dimensional (2D) printer or a three-dimensional (3D) printer. In some examples, the service station may perform drop detection of a fluid through nozzles (e.g., print nozzles) of the printer for quality assurance of printed parts. In a particular example, the drop detection may be binary in determining that a nozzle ejects fluid or does not eject fluid. The nozzles may be on a print assembly or print bar of the 3D printer.

In some examples of a 3D printer to print a 3D object, the 3D printer may eject fluid through the nozzles onto material such as powder, and apply light or heat to the ejected fluid and powder mixture to form the 3D object layer-by-layer from the material. The 3D printer may have a light source or heat source (e.g., heat lamps, infrared light source, etc.) to apply the light and/or heat to each layer. As used herein, a light source may be considered or called a heat source for instances such as with infrared (IR) light. In some examples, fusing lamps are employed and may be labeled as a light source or a heat source. As used herein, the term “powder” can, for example, refer to a powdered material which may be layered and bound via a binding material during a print job of a 3D printing process. The powdered material can be, for example, a powdered semi-crystalline thermoplastic material, a powdered metal material, a powdered plastic material, a powdered composite material, a powdered ceramic material, a powdered glass material, a powdered resin material, and/or a powdered polymer material, among other types of powdered material.

As for servicing, the service station may include a spit surface or a spit roller having a spit surface to receive the fluid ejected from the nozzles during the drop detection outside of the printing. The fluid used for printing may be labeled as spit fluid when the fluid is ejected for nozzle or drop detection, or for other servicing. The spit surface may have an opening or slot, and work in conjunction with, for example, a vacuum system to capture and remove the spit fluid ejected from the nozzles during drop detection. In one example, a spit roller has a spit surface and a vacuum slot along the length of the spit roller or spit surface.

To avoid or reduce solidifying or hardening of residual spit fluid or other compounds on the spit surface, the service station includes a rotation device (e.g., a flipper mechanism) to move or turn the spit surface or spit roller in response to movement of the heat source toward the service station, or near or over the service station. In one example, movement of the heat source toward the service station comprises movement of a powder spread roller of the printer toward the service station. The rotation device rotates the spit roller or otherwise turns the spit surface away from facing the heat source. In some examples, turning the spit surface away from the heat source also includes turning the spit surface away from airborne powder.

The rotation device may also provide a shield for the service station in the drop detection area such that residual powder that might enter the area during printing would not collect inside (e.g., deep inside) the service station. The same shielding may also prevent small parts, either printed in 3D printing or service parts such as screws, from falling into mechanisms in and around the drop-detection area, such as during 3D part extraction or during servicing of the printer, and so forth.

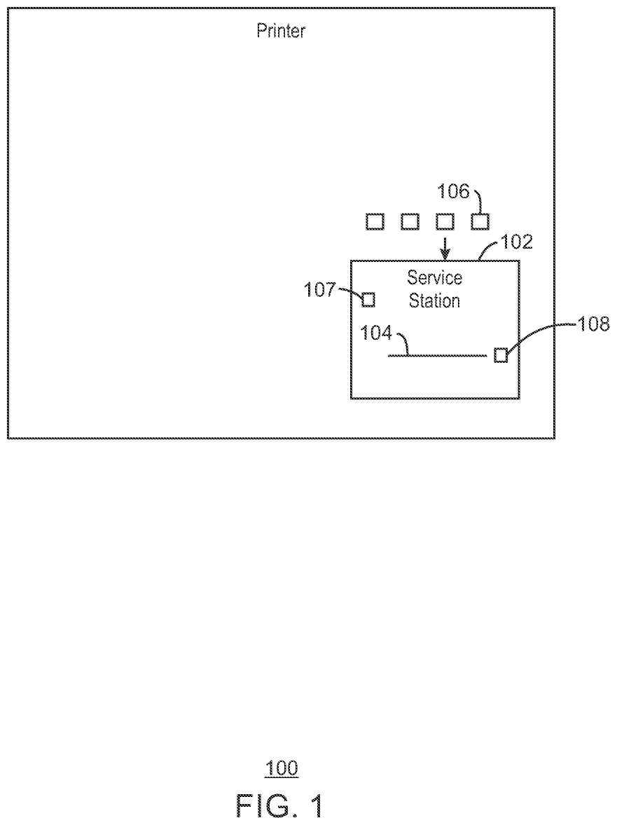

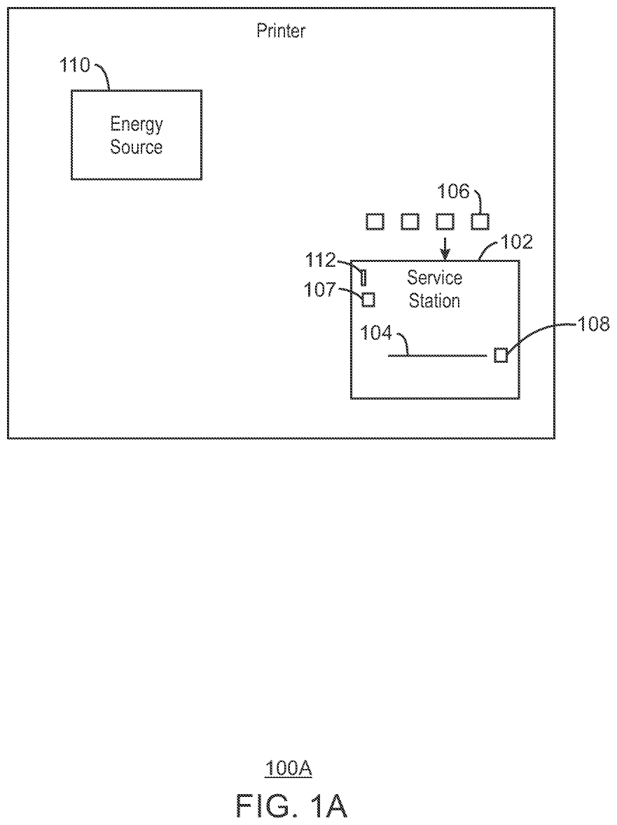

FIG. 1 is a printer 100 having a service station 102. The service station 102 includes a surface 104 (e.g., a spit surface) to receive fluid (e.g., spit fluid) ejected from nozzles 106 of the printer 100. The nozzles 106 may be print nozzles. Further, the nozzles may be on a print bar of the printer 100. During printing, the printer 100 may employ the nozzles 106 to eject fluid (e.g., liquid) to print a product or object.

During servicing, the printer 100 may eject fluid (e.g., liquid) from the nozzles to the surface 104 for the service station 102 to perform testing of the nozzles 106. For example, the testing may include drop detection. In other words, the service station 102 may have, for example, a sensor 107 to detect the ejection or flow of the fluid from the nozzles 106 to the spit surface 104. In particular examples, the determination may be binary. For instance, if some flow or typical flow is detected through a nozzle 106 to the surface 104, that nozzle 106 may be determined as functioning. On the other hand, if little or no flow of fluid is sensed from a nozzle 106 to the surface 104, that nozzle 106 may be determined as not functioning. Other sensing, logic, determinations, and conclusions with respect to drop testing are applicable. Further, in some cases, the sensor 107 may be labeled as a drop-detector sensor.

The service station 102 includes a rotation device 108 (e.g., having a motor) to move or turn the surface 104 from a first position to at least a second position. The first position may be the surface 104 positioned to receive the fluid from the nozzles 106 in the drop detection. The second position may be the surface 104 not in position to receive the fluid from the nozzles 106 for the drop detection. In some circumstances, the service station 102 may turn, via the rotation device 108 or other component, the surface 104 from the first position to the second position at the completion of drop testing and when the service station 102 is not performing drop detection. In addition, the service station 102 may turn, via the rotation device 108, the surface 104 to the first position (e.g., a drop-detection position) at initiation of the drop detection.

In particular examples, the printer 100 may time-interleave printing and drop detection, or for example, time-space the printing and drop detection at relatively fast alternating time intervals, and the like. In some examples, the service station 102 may maintain the surface 104 in the first position including during periods of time (e.g., brief moments of time) when the service station is not performing drop detection. However, the service station 102 may turn, via the rotation device 108, the surface 104 to the second position (e.g., not a drop-detection position) based on or in response to operating conditions of the printer 100. For example, as discussed below, the second position and additional positions of the surface 104 implemented via the rotation device 108 may be the surface 104 turned away from an energy source (e.g., light source, heat source, heat lamps, a combined light/heat source, etc.) of the printer 100. If so, application of energy (e.g., light, heat, IR light/heat, UV light, etc.) from the energy source to the fluid on the surface 104 may be avoided or reduced with the surface 104 not in the first position. Moreover, it should be noted that the energy source may be a light source to apply but that is a heat source in a sense that an effect of applying the light (e.g., IR light) is that heat is applied. Therefore, in that example, the energy source may be called a heat source though a primary reason of that heat source is to apply light.

As mentioned for printing operation, the printer 100 may employ the nozzles 106 to eject fluid to print a product or object. In some examples, the same fluid used for printing may also be used in servicing in the drop detection. If so, the fluid when employed (e.g., ejected through the nozzles) in servicing or drop detection may be labeled as spit fluid. Indeed, when the fluid used in printing is ejected from the print nozzles 106 for servicing, the fluid may be characterized as spit fluid during the servicing including testing. In this context, the surface 104 may be labeled as a spit surface which may be a surface that receives spit fluid.

Moreover, in certain examples, the surface 102 may have an opening or rely on a vacuum system of the service station 102, or both, to facilitate removal of the fluid or spit fluid from the surface 104. Indeed, the spit fluid ejected from the nozzle 106 during testing may be directed to the opening on the surface 104. Other components of the service station 102, such as a scraper, may be involved in removing fluid and other material from the surface 104.

FIG. 1A is a printer 100A having a service station such as the service station 102 depicted in FIG. 1. The printer 100A includes an energy source 110 employed in printing. In some examples, the printer 100A may apply energy via the energy source 110 to the fluid during or after ejection of the fluid through the nozzles when the printer 100A is printing a product with the fluid. The fluid may be exposed to the energy from the energy source 110 as or after the fluid is applied in the printing. The energy source 110 may be a heat source (e.g., heat lamp(s)), light source (e.g., infrared light, ultraviolet light, etc.), laser source, electron beam source, or any combinations thereof. In certain examples, the printer 100A may move and position the energy source 110 during printing.

During drop detection of the nozzles 106 by the service station 102, the printer 100A may be preparing for or implementing printing and, thus, move the energy source 110 for the desired printing. In some cases, the printer 100A may move the energy source 110 toward (e.g., near, adjacent, above, etc.) the service station 102. In response, the service station 102 may turn, via the rotation device 108, the surface 104 away from the energy source 110, such as from the aforementioned first position to the second position or other position. Therefore, application of energy to any fluid on the surface 104 may be avoided or reduced. Thus, in examples, hardening, solidification, gelling, etc. of the fluid on the surface 104 may be reduced.

Some examples of the printer 100A and the printer 100 of FIG. 1 may be a three-dimensional (3D) printer that prints or forms a 3D object via the fluid. In certain examples, the fluid may be ejected from the nozzles 106 to a build bed having build material including powder. In particular examples, the powder may be considered the print media. In one example, the powder is Nylon powder. In general, the printer 100, 100A may lay the fluid on the powder. The energy source 110 such as an IR light source may melt a combination of the powder and the fluid. Indeed, the energy from the energy source 110 applied to the fluid on the build material may facilitate reaction of the fluid with the powder, and/or fuse the powder, and the like, for the printer 100A to form the 3D object. The 3D object may be formed layer-by-layer (e.g., layers of about 80 microns in thickness).

Again, in certain examples, that same fluid type or similar fluid may be ejected through the nozzles 106 as spit fluid to the surface 104 for the service station 102 to perform drop detection. The drop detection may an indication or measurement of reliability of a nozzle 106 to lay down the fluid during 3D printing. The degree of reliability of nozzle 106 functioning may impact cosmetic properties (e.g., streaks, lines, etc.) of the 3D object and strength (e.g., elongation strength) of the 3D object. Moreover, aerosol may be an unwanted side effect of printing, servicing.

The service station 102 may have a shield 112 to isolate at least a portion of the drop-detection area of the service station 102 from the remainder of the printer 100A, such as when drop detection is not being performed and to protect the service area from aerosol. The service station 102 may so position the shield 112 via the rotation device 108 or another device. The drop detection area isolated may include or be near, for example, the surface 104 and the sensor 107.

The shield 112 may be plastic, polymer, or metal, and may be a strip, plate, or the like. The shield 112 in the isolating position may reduce or prevent material from the printer 100A entering the isolated drop detection area or entering the isolated portion the of the drop detection area. Such material may include dislodged mechanical parts, build material, powder, aerosol material such as airborne powder or airborne fluid, and so on.

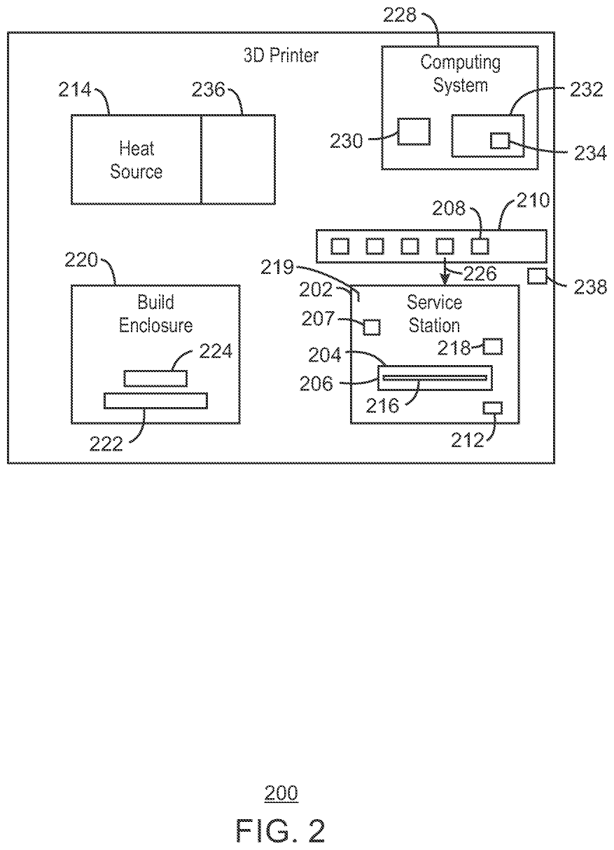

FIG. 2 is a 3D printer 200 having a service station 202 including a surface 204 (e.g., spit surface, service surface, etc.) for the service station to perform drop testing of nozzles, as discussed below. In some examples, the surface 204 is a surface of a roller 206 or a portion of a surface of the roller 206. The roller 206 may be a spit roller, service roller, and the like. In certain examples, the roller 204 may be generally cylindrical in shape. Other shapes and geometries for the roller 204 are applicable.

As also discussed below, the service station 202 includes a sensor 207 for the service station 202 to perform drop detection on the nozzles (e.g., print nozzles) of the 3D printer 200. In the illustrated example, the nozzles 208 may be disposed on or components of a print assembly or print bar 210. In some examples, a print bar may have hundreds or thousands of print nozzles 208 or dies having print nozzles 208. In certain examples, the service station 202 may perform drop detection on each nozzle 208.

Further, the service station 202 has a rotation device 212, for example, to turn the surface 204 of the roller 206 away from a heat source 214 in response to the 3D printer 200 moving the heat source 214 toward or near the service station 202. The heat source 214 may be employed in 3D printing by the 3D printer 200. The heat source 214 may be a heat lamp, heating element, light source, laser source, and so on, or any combinations thereof. To turn the surface 204 away from the heat source 214, the rotation device 212 may rotate the roller 206 in some examples. Moreover, the service station 202 may rotate the roller 206 to turn the surface 204 from a first position (e.g., drop-detection position) to a second position (e.g., not a drop-detection position) for various reasons, such as those indicated above in the discussion of FIGS. 1 and 1A. The rotation device 212 may have a motor. The rotation device 212 may also have a coupler to interface with the spit roller 206.

The roller 206 may include an opening 216 for the service station 202 to remove fluid from the surface 204. In the illustrated example, the opening 216 is a slot along a length of the roller 206. In some examples, a vacuum system 218 may be coupled to the opening 216 to further facilitate removal of fluid from the surface 204. Indeed, the service station 202 may operate the vacuum system 218 to pull a vacuum from the surface 204 through the opening into an interior of the roller 216 and into a conduit of the vacuum system in certain examples. The vacuum system 218 may include conduits (e.g., tubing, piping, etc.), vacuum pump, venturi, filter, and so forth. Moreover, in the drop detection testing of the nozzles 208, the spit fluid ejected from the nozzles 208 may be directed to the opening 216 by the service station 202. In one example, a vacuum pump of the vacuum system 218 discharges the removed fluid through a filter of the vacuum system. In some examples, the vacuum system couples to the spit roller 206 via an end portion of the service roller 206, a port or opening in the service station 202, and so on.

The service station 202 may include a shield 219 which may be a plate, bar, lip, bar, strip, or other obstruction. The rotation device 212 and/or other features of the service station 202 may provide for the shield 219 to cover, for example, opening or holes that exist generally or during printing. The rotation device 212 may rotate the roller 206 and position the shield 219 independently of rotating the roller 206 in certain examples, at least for some amount of rotation of the roller 206.

The shield 219 may block or restrict material from entering the drop-detection area of the service station 202. For example, the shield 219 may block or restrict residual build material (e.g., powder) that might enter the area during printing from entering and collecting inside (e.g., deep inside) the service station 202 such as in the drop detection area. The shield 219 may also prevent or reduce occurrence of small parts from falling into the drop-detection area, such as during 3D part extraction or during servicing of the printer 200, and so forth. The parts susceptible to entry to the drop-detection area from the remainder of the printer 200 may include printed objects, service parts such as screws, and the like.

During drop detection, a gap or opening (e.g., a relatively large gap) between the service station 202 and the remainder of the printer 200 may exist to give the drop-detection sensor carriage a running clearance to perform tasks. The shield 219 may close or obstruct this opening when drop detection is complete or not being performed (and with the drop-detection carriage not active). Such positioning of the shield 219 may be implemented via the rotation device 212 and may, for example, be implemented independent of rotating the spit roller 206.

To perform 3D printing, the 3D printer 200 may have a build enclosure 220 with a build platform 222. The 3D printer may print or form, via the build platform 222, the 3D object 224 from build material (e.g., powder) and fluid on the build platform 222. For example, in operation, a build bed of material may be disposed on the build platform 222 and in which fluid may be applied, and powder fused or sintered layer-by-layer to form the 3D object 224. As defined herein, build material may include powder(s) and powder-like materials. The powder may be plastic, polymer, metal, ceramic, glass, concrete, composite material, or other powders.

To generate the 3D object 224, the 3D printer 200 may form via the build platform 222 successive layers with the build material (including powder and with portions of the powder as melted, fused, solidified, etc.) under computer control to fabricate the 3D object 224. The 3D objects 224 so formed can be various shapes and geometries, and produced via a model such as a 3D model or other electronic data source. The 3D printing and fabrication by the 3D printer 200 may involve sintering, melting, fusing, or fusion of the material or powder by energy sources such as a laser, electron beam, light, ultraviolet light, heat, and so forth. Indeed, this may involve laser melting, laser sintering, electron beam melting, fused deposition or fusion, and so on. The 3D printing may involve other AM printing techniques. Moreover, the model and automated control may facilitate the layered manufacturing and additive fabrication. As for applications, the 3D printer 200 may fabricate objects 224 as prototypes or products for aerospace (e.g., aircraft), machine parts, medical devices (e.g., implants), automobile parts, fashion products, structural and conductive metals, ceramics, conductive adhesives, semiconductor devices, and other applications.

In a particular example, such as with fusion or fused deposition, light or heat from the heat source 214 may be applied to the fluid ejected from the nozzles 206 onto the build powder to fuse powder at specific points each layer to form the 3D object 224. In certain instances, the heat and/or light applied to the fluid may facilitate reaction of the fluid and powder to give, for example, fusion of desired portions of the powder on each layer. Indeed, specific points or areas of fluid application to the build bed, and specific points or areas of light or heat applied to the fluid on the powder, may be driven by computer control such as under direction of a 3D model. In some examples, the build platform 222 resides on a movement device (e.g., a piston) that is incrementally lowered as the 3D object 224 is formed layer-by-layer. After completion of the print job, the 3D object 224 may be removed from the 3D printer 200. In examples, the 3D object may be subjected to additional processing, such as post-processing, finishing, and so forth. Lastly, the print fluid may be ejected from the nozzles 208 as spit fluid 226 with the nozzles 208 moved from over the build platform 222 to the service station 202 over the spit surface 204.

The 3D printer may include a computer system 228 having a processor 230 and memory 232. The hardware processor 230 may be a microprocessor, central processing unit (CPU), and the like. The processor 230 may be one or more processors, and may include one or more cores. The memory 232 may include volatile memory such as random access memory (RAM), cache, and the like. The memory 232 may include non-volatile memory such as a hard drive, read only memory (ROM), and so forth. The computer system 228 may include code 234 (e.g., instructions, logic, etc.) stored in the memory 232 and executed by the processor 230 to direct or facilitate various techniques discussed herein with respect to directing operation of the rotation device, turning of the surface 204, rotation of the roller, positioning of the shield 219, and so on. Moreover, the computer system 228 may be involved in other operations of the service station 202 (e.g., drop detection and other servicing) and the 3D printer 200.

The 3D printer 200 may include a carriage 236 and associated components for movement of the heat source 214 and for printing of the 3D object 224. The carriage 236 may include components such as powder spreader or powder spreading arm, and other devices. Furthermore, the printer 200 may include additional sensors 238 outside of the service station 202 for operating or maintaining the print bar 210 and the nozzle 208.

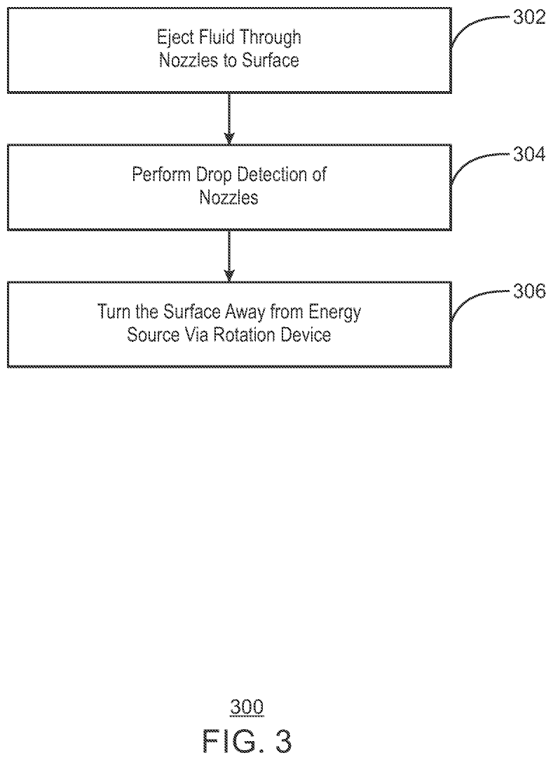

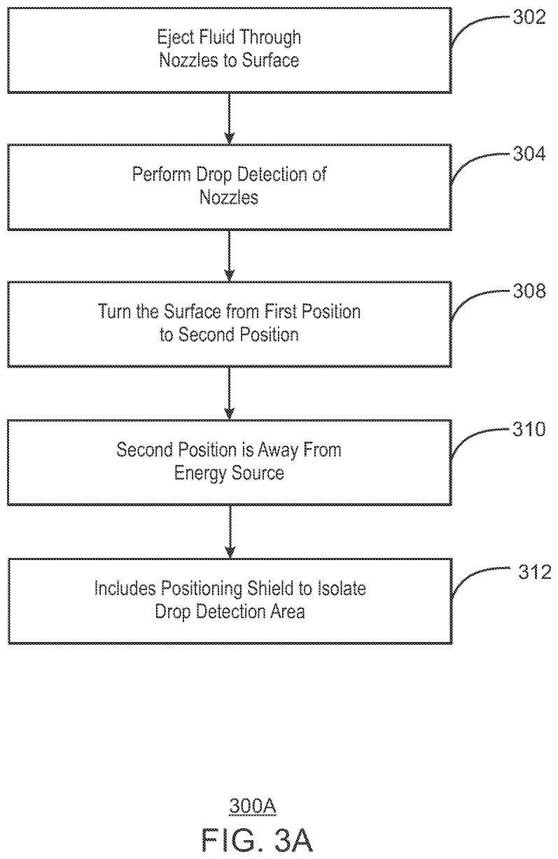

FIG. 3 is a method 300 of operating a printer. At block 302, the method includes ejecting fluid from nozzles of the printer to a surface of a service station of the printer to perform drop detection of the nozzles via the service station. The nozzles may be print nozzles disposed on a print bar. Also, the fluid may be spit fluid and the surface may be a spit surface. Furthermore, in certain examples, the method may include removing the fluid from the surface via an opening on the surface and via a vacuum system. In particular examples, a spit roller of the printer has the surface, and the opening is a slot along a length of the spit roller.

At block 304, the method includes performing the drop detection. The printer may have a drop detector to sense the spit fluid ejected from the nozzles to the surface. Further, the spit fluid from the print nozzles during testing may be directed to the vacuum opening or slot on the spit surface. Furthermore, in some examples, the printer is a 3D printer and the drop detection is performed for quality assurance of 3D objects printed by the 3D printer. Moreover, in one example, the drop detection is binary in determining that a nozzle functions or does not function.

At block 306, the method includes turning the surface via a rotation device of the service station. For example, the rotation device may turn the surface away form an energy source of the printer. The energy source may be, for example, a light source or a heat source, or a combination thereof. In particular examples, the rotation device may turn the surface away from the energy source in response to movement of the energy source toward the service station. The movement of the energy source toward the service station may include movement of a powder spreader (e.g., a powder spread roller) toward the service station. Furthermore, the turning of the surface away from the energy source may also include turning the surface away from airborne powder.

Moreover, in cases with a spit roller having the surface, the turning of the surface may involve the rotation device rotating the spit roller. In examples, the rotation device has a motor. The rotation device may also have a coupler to interface with the spit roller.

The method 300 may include additional actions such as printing an object via the nozzles. For example, a print bar having the nozzles as print nozzles may eject fluid to print the object. The print bar may eject the print fluid through the print nozzles to a bed of build material including powder to form the object from the build material. The energy source may apply energy, such as heat and/or light, to the fluid to fuse build material such as powder to print the object. Lastly, as indicated above with respect to the preceding figures and as discussed below, another action may include the rotation device positioning a shield in the service station to at least partially isolate a drop-detection area of the service station from the remainder of the printer.

FIG. 3A is a method 300A of operating a printer. In some examples, the printer is a 3D printer. At block 302 (discussed with respect to FIG. 3), the method 300A includes ejecting fluid from nozzles of the printer to a surface in a service station of the printer to perform drop detection of the nozzles via the service station. The surface may be a spit surface and may be a surface of a roller or spit roller. Further, the surface may have a vacuum opening or vacuum slot in which the spit fluid is directed during the drop detection. At block 304 (also discussed with respect to FIG. 3), the method 300A includes performing the drop detection. Again, the printer may have a drop detector to sense the spit fluid ejected from the nozzles to the surface.

At block 308, the method includes turning, via a rotation device, the surface from a first position to a second position. In some examples, this action involves rotating a spit roller. Moreover, in examples, the surface (and any associated vacuum opening or vacuum slot) in the first position may be positioned to receive spit fluid ejected from the print nozzles for the drop detection. The drop detector may sense the spit fluid ejected from the print nozzles to the surface in the first position. The rotation device may turn the surface from the first position to a second position in which the service station does not perform the drop detection in the second position.

In examples, the rotation device turns the surface from the first position to the second position away from the energy source, as referenced in box 310. In some examples, the method may include the rotation device turning the surface from the first position to the second position or additional positions in response to the service station completing the drop detection or not performing drop detection.

In addition, as indicated in block 312, turning the surface from the first position to the second position (or to a third position or other positions) may dispose or position a shield in the service station to isolate a drop detection area from the remainder of the printer. In one example, block 312 may be turning the surface to a third rotational position of the surface or spit roller, and which may also be away from the energy source.

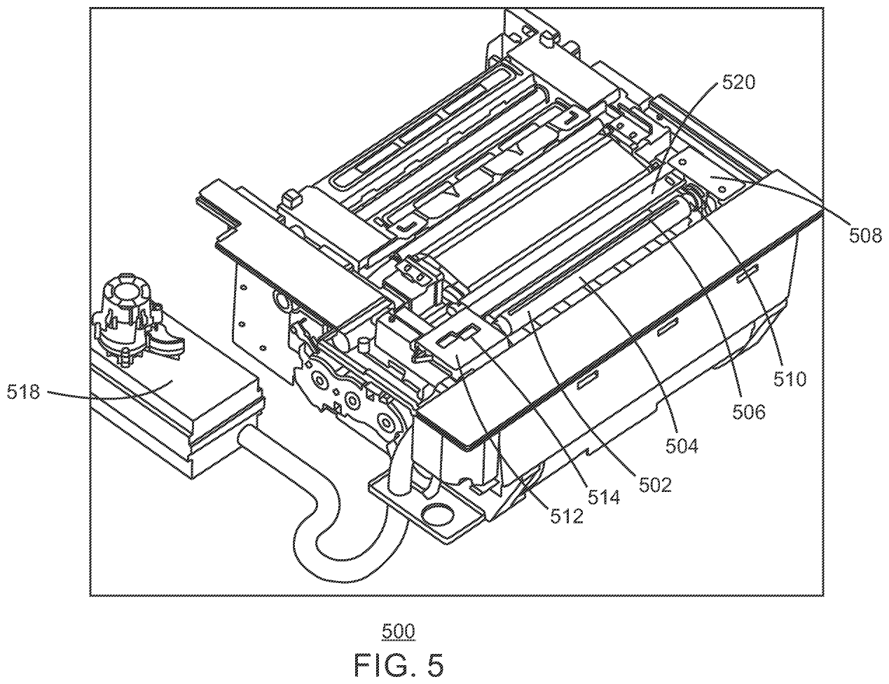

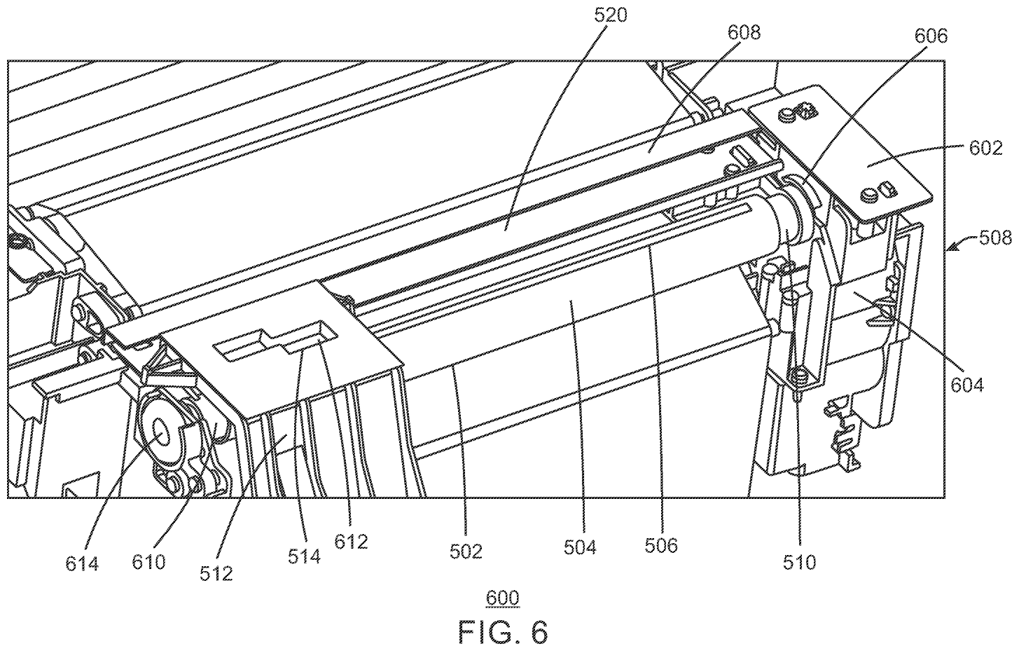

In a particular example, there are at least three positions of the spit roller: (a) sense enabled, (b) sense disabled, and (c) sense disabled and isolated. Moreover, in the particular example, there are at least two positions of the rotational device: (1) drop-detection carriage enabled and (2) drop-detection carriage disabled. See FIGS. 5-8 and the associated text in the description below. To further explain for this particular example, the (a) drop-detection carriage enabled can have or be associated with two roller positions (a) sense enabled and (b) sense disabled. The (2) drop-detection carriage disabled may correspond with the roller position (c) sense disabled and isolated.

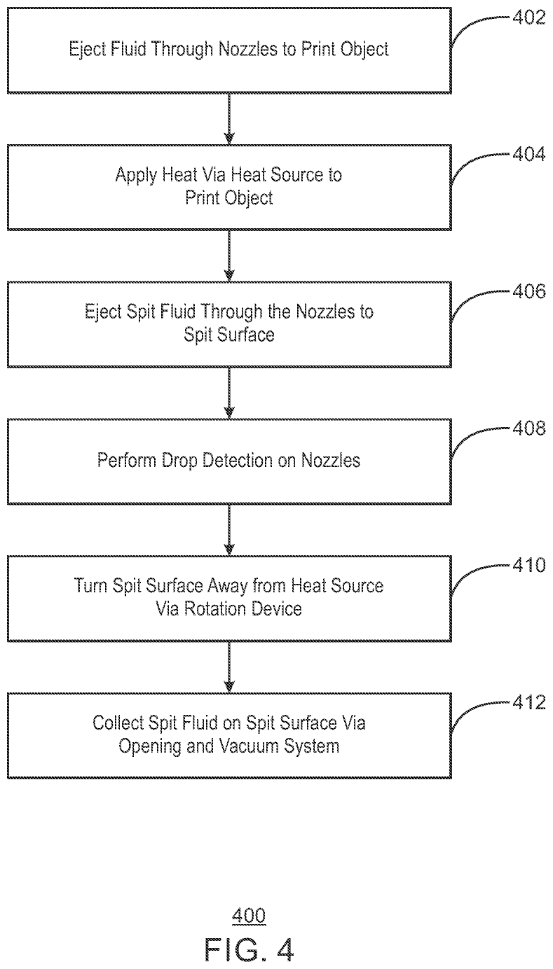

FIG. 4 is a method 400 of operating a printer. At block 402, the method includes ejecting fluid through nozzles to print an object. The nozzles may be print nozzles on a print assembly or print bar of the printer. In one example of a 2D printer, the fluid includes ink. In an example of a 3D printer, the fluid includes components to fuse material (e.g., powder) on a build platform of the printer. Examples of fluid in 3D printing may include fusing agents, colorants, and/or detailing agents, and the like.

At block 404, the method includes applying heat via a heat source (or light via a light source) to print the object. In the example of the 3D printer, the method includes applying heat via the heat source to the fluid on the powder on the build platform to activate the fluid interaction with the powder to fuse the powder. This may include applying light (e.g., ultraviolet, infrared, etc.) via a light source to the fluid on the powder on the build platform to activate the fluid interaction with the powder to fuse the powder. The powder (with fluid) may be fused layer-by-layer to print the 3D object.

At block 406, the method includes ejecting spit fluid through the nozzles to a spit surface of a service station of the printer to perform drop detection of the nozzles. In some examples, the spit fluid may be the same type of fluid used in printing. At block 408, the method includes performing the drop detection. As mentioned, the service station may have a drop detector to sense the spit fluid ejected from the nozzles to the surface for the service station to perform the drop detection. In some examples, the drop detector includes a beam emitter and a beam collector or beam acceptor. The beam may be directed from the emitter toward the acceptor through a path of the spit fluid ejected from a nozzle to the spit surface. In one example, interruption of the light beam may indicate the presence of spit fluid and that the nozzle is functioning.

At block 410, the method includes turning the spit surface away from the heat source or the light source via a rotation device of the service station. In one example, the spit surface may be turned away from the heat source or the light source in response to movement of the heat source or the light source toward or near the service station. Moreover, in cases of the service station having a spit roller having the spirt surface, the rotation device may rotate the spit roller to turn the spit surface away from the heat source or the light source.

At block 412, the method includes collecting spit fluid from the spit surface via an opening on the surface and via a vacuum system. The vacuum system may be a vacuum system of the service station or of the printer generally. Further, the vacuum system may be coupled to the spit surface at the opening. In one example of the spit surface as the spit surface of a spit roller, the opening is a slot along a length of the spit roller.

FIG. 5 is a service station 500 of a printer. The service station 500 includes a spit roller 502 having a spit surface 504. The spit surface 504 may receive spit fluid from print nozzles of the printer for the service station 500 to perform drop detection of the print nozzles. The spit roller 502 includes a slot 506 along a length of the spit roller 502 to accept spit fluid from the spit surface 504. For example, the slot 506 may receive the spit fluid to free the spit surface 504 of spit fluid and including when the service station 500 desires to clean the spit surface 504.

The service station 500 includes a rotation device 508 to rotate the spit roller 502. In the illustrated example, the rotation device 508 includes a coupler 510 that interfaces with the spit roller 502. The coupler 510 may sit inside the spit roller 502 or inside an end portion of the spit roller 502, and not attach to the spit roller 502. Further, in examples, the rotation device 508 includes a motor. The rotation device 508 may rotate the spit roller 502 via the coupler 510 and the motor. The service station 500 may rotate the spit roller 502 via the rotation device 508 in response to operating conditions of the printer. Examples of such operating conditions may include drop detection not being performed, or to turn the surface 504 away from a moving energy source of the printer approaching the service station 500, and so on.

The service station 500 includes a drop-detector carriage 512. In examples, the drop-detector carriage 512 may include sensors such as through-beam drop detectors. Therefore, in examples, the service station 500 may perform through-beam drop detection of the printer nozzles via the drop-detector carriage 512. In operation, the service station 500 may move the drop-detector carriage 512 along and over the spit roller 502 and spit surface 504. In FIG. 5, the drop-detector carriage 512 is depicted in a position to the left of the spit roller 502, which is the rear of the service station 500 in the illustrated example. The service station 500 may move the drop-detector carriage 512 from the depicted position to the right along and above the spit roller 502 toward the front of the service station 500.

In this example, the drop-detector carriage 512 has two receptacles or cavities 514. Spit fluid may eject from print nozzles down through the cavities 514 to the spit surface 504 below. In the illustrated example, the two cavities 514 are offset or staggered to mate with staggering of respective arrays of print nozzles on an above print bar of the printer. The two cavities 514 each have a pair of drop-detector sensors. The drop-detector sensors in each cavity 514 may be a drop detector having two components, a beam emitter and a beam collector, installed on opposite interior walls of a cavity 514. There may be two emitter-collector pairs in each cavity 514.

In operation, the printer may position the print nozzles of the print assembly or print bar over the spit roller 502 and with the print nozzles elevated above the drop-detector carriage 512. The service station 500 may move the drop-detector carriage 512 across the spit roller 502 under the print nozzles, such as at a relatively slow and substantially constant velocity so that print nozzles can individually eject spit fluid through the cavity 514 to the spit surface 504 below the drop-detector carriage 512. The drop detector in the cavity 514 may sense presence of the flowing spit fluid or lack thereof. The service station 500 may perform drop detection and determination of a functioning status of a print nozzle based on this sensing by the drop detector. Moreover, the drop-detector carriage 512 may make multiple passes over the spit roller 502 interfacing with different print nozzles or dies having print nozzles on the overhead print bar.

The service station 500 may have a vacuum system 518 which may include a vacuum pump, a filter, and a conduit coupling the vacuum pump to the spit roller 502. In some examples, the vacuum pump may discharge through the filter. The service station 500 may remove spit fluid from the spit surface 504 via the vacuum system 518 and the slot 506 along the spit roller 502. In some examples of drop detection, the spit fluid ejected from the nozzles may be directed to the slot 506. Lastly, the service station 500 may include an anti-rotation (AR) rail 520 to prevent or reduce rotation of the drop-detector carriage 512.

FIG. 6 is a printer service station 600 and which may be analogous to the service station 500 of FIG. 5. The service station 600 includes the spit roller 502, the spit surface 504 on the spit roller 502, and the vacuum slot 506 on the spit roller 506. The service station 600 includes the rotation device 508 which has an upper plate cover 602 and a motor 604. The rotation device 508 also includes a front coupler 510 and a rear coupler 610 both of which interface with the spit roller 502. A shield 606 protect a gear underneath from energy (e.g., IR light) from the energy source.

The front coupler 510 and the rear coupler 610 may be fastened to the AR rail 520. If so, the AR rail 520 when coupled to the spit roller 502 through the front coupler 510 and the rear coupler 610 moves or rotates with the spit roller 502, such as between stops or hard stops. The service station 600 also includes an aerosol shield 608 (e.g., an AR rail shield).

The service station 600 has the drop-detector carriage 512 which includes the two cavities 514 in the illustrated example. Each cavity 514 has sensors 612 which may be a drop detector (e.g., a through-beam drop detector), as discussed above. Further, the service station 600 includes a port 614 to couple the vacuum system 518 (see FIG. 5) with the spit roller 502. Lastly, operation of the service station 600 and its components may be the same or similar as the operation of the service station 500 discussed above with respect to FIG. 5.

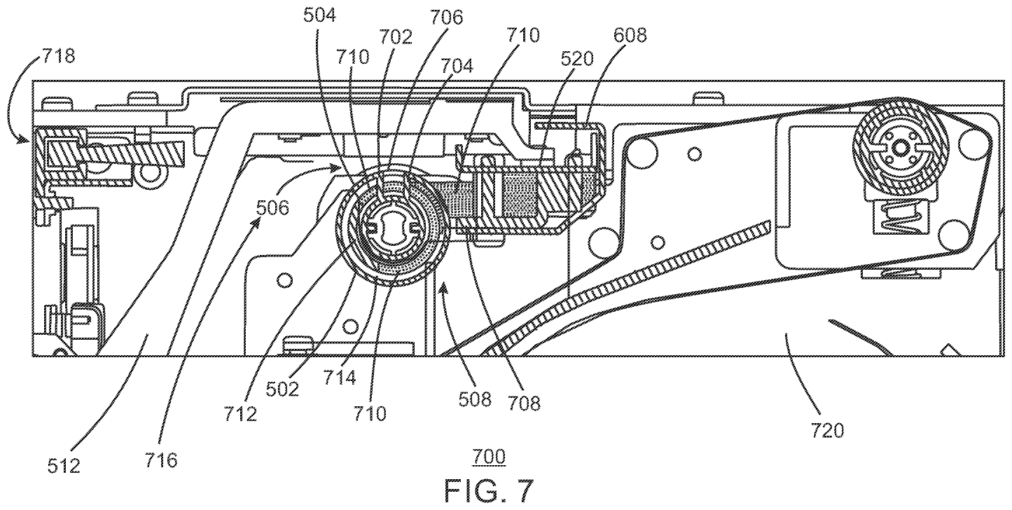

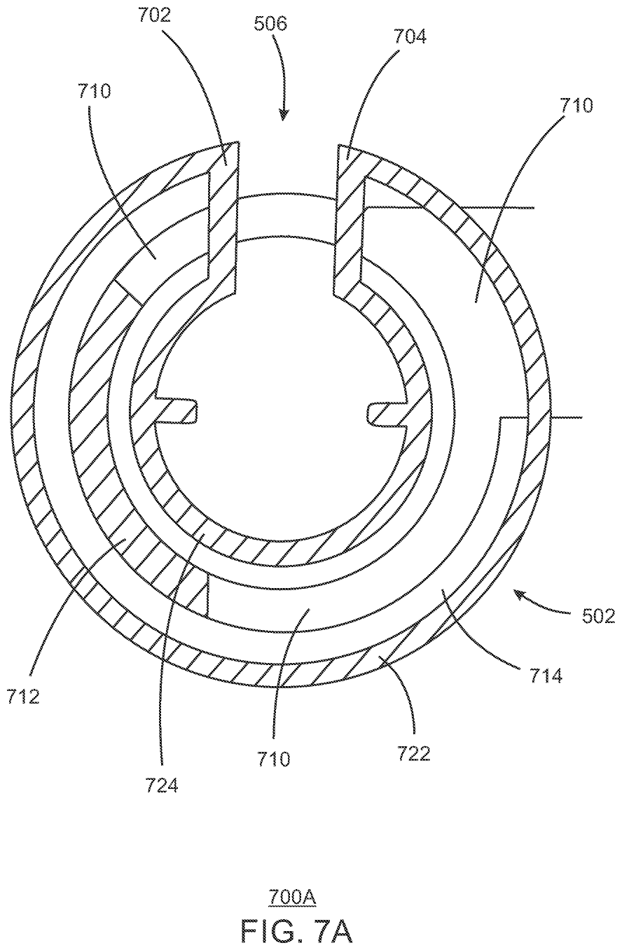

FIG. 7 is a cross-section representation of a printer service station 700 from the front of the service station 700. The service station 700 may be analogous to the aforementioned service stations 500 and 600. The spit roller 502 of the service station 700 includes two portions 702 and 704 defining the vacuum slot 506 of the spit roller 502. In this example, the portion 702 may act as a rib 702 of the spit roller 502. The rib 702 may stop against a rib 712 of the front coupler 510 in certain modes or operating conditions of the service station 700. In one example, rotational positions of the spit roller 502 or rotation device 508 may determine if meeting of stops is realized.

The spit roller 502 had an outer cylinder 706 adjacent a gap 714. Further, the rib 712 of the front coupler 510 (see FIG. 5) may interact as a stop (e.g., hard stop) with the spit roller 502. Further, in this example, the service station 700 includes a scraper 708. The service station 700 also includes a coupler 710 such as the coupler 510 (see FIGS. 5-6). Moreover, the service station 700 in the depicted drop-detection position reveals an opening 716 between the drop-detection area and the remainder of the printer. The opening 716 accommodates the swept volume of the drop-detector carriage 512. Lastly, in the illustrated example, the service station 700 includes a bush seal 718 and a wiper housing 720.

As mentioned, the service module 700 is depicted in the drop-detection sense position, as indicated by the slot 506 on the spit roller 502 facing up. The rotation device 508 is in an open operating mode with the AR rail 520 stopped against the wiper housing 720 (e.g., a wiper applicator housing). The spit roller 502 is in the spit position for drop detection. Again, the vacuum opening or slot 506 is pointed up to receive spit fluid as well as receive aerosol residuals, for example. The spit roller 502 is decoupled from the AR rail 520. The rib 712 of the coupler 510 is not in contact with the drive rib 702 on the spit roller 502.

The printer includes a heater spreader carriage which may have a heater (e.g., light) as an energy source, and also a powder spreader. The full range of motion of the heater spreader carriage includes motion to the right of the printer which brings it over service station 700 and particularly into the area of operation for the drop-detector carriage 512. In the illustrated example, the heater spreader carriage is outside of the service station 700 to the left in the figure and, thus, the drop-detector carriage 512 can safely move out onto the AR rail 520 generally without melting issues.

In the depicted drop-detection position of the AR rail 520, the aforementioned opening 716 accommodates the swept volume of the drop-detector carriage 512. Powder may encroach from the printer build area into the servicing area including the drop-detection area. Also, both the AR rail 520 and the spit-on side of the spit roller 502 are pointed up and thus are exposed to powder and printing fluid aerosol, as well as potential exposure to light (e.g., infrared or IR light) in the event that the heater-spreader carriage returns to the servicing side (right) of the printer.

FIG. 7A is a more detailed view of a portion 700A of the service cartridge 700 of FIG. 7. The spit roller 502 has at least two concentric portions: (1) an outer portion 722 (which may be analogous to the aforementioned outer cylinder 706) and (2) an inner surface 724. These two portions 722 and 724 may create the interior gap 714 in the spit roller 502. The two concentric portions 722 and 724 may be connected by the two sides of the vacuum slot portions 702 and 704. In some examples, at either end of the spit roller 502, the outer portion 722 may be machined away, and front and rear couplers 710 (e.g., including coupler 510) may be fit (e.g., loosely) over the remnant of the inner portion 724. The couplers (front and rear) 710 each have a rib 712 that points inward towards spit roller 502 and penetrates (e.g., loosely) into the gap 714. The couplers 710 may also be attached (e.g., rigidly) to the anti-rotational rail 520 and the aerosol shield 608, which in union may define the rotational device (e.g., “flipper mechanism”). See FIGS. 5-6. During operation, the spit roller 502 may be free to rotate independently of the loose-fitting couplers 710 until one of the vacuum slot ribs 702 and 704 contacts the coupler penetrating ribs 712. If the rotation is clockwise, vacuum rib 704 may generally drive the rotational device 508 or flipper mechanism to the open position. In one example, this may be labeled as the drop-detector carriage 512 enabled position. If the rotation is counterclockwise, the vacuum slot rib 702 may drive the rotational device 508 or flipper mechanism to the closed position. In some examples, this may be labeled as the drop-detector carriage 512 disabled position.

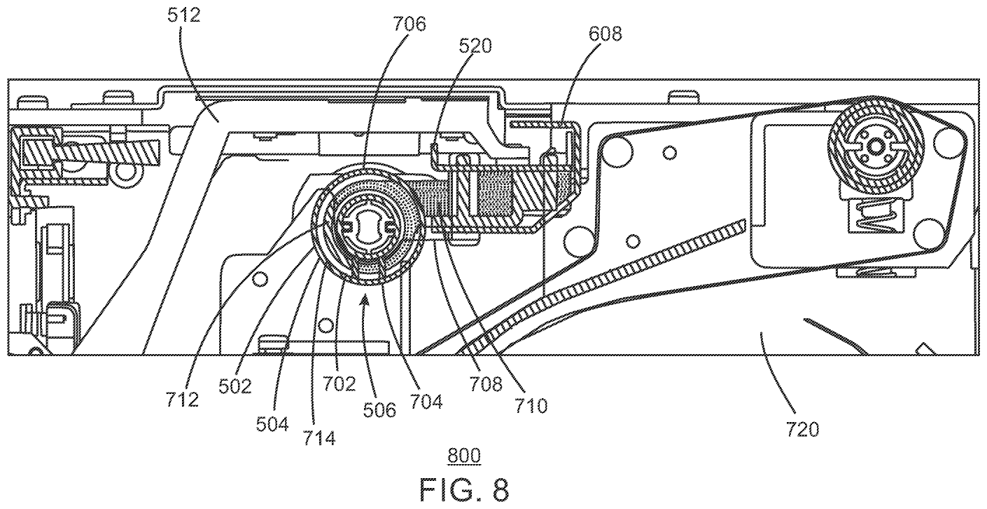

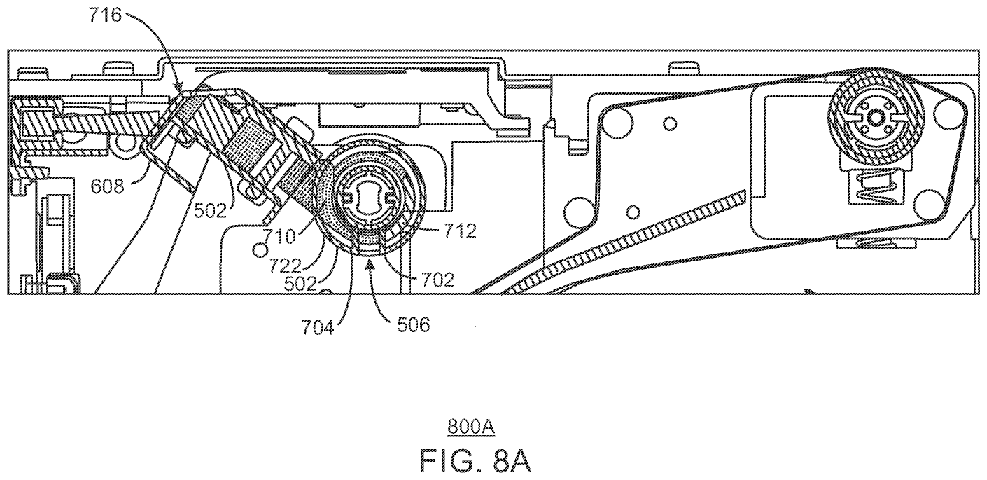

FIG. 8 is a cross-section representation of a printer service station 800 from the front of the service station 800. The service station 800 may be the service station 700 of FIG. 7 but depicted in a post drop-detection operating position. Further, the heater spreader carriage is traveling left to right so the agent-soiled spit roller 502 should roll away to shield residual fluid and aerosol (due to the act of drop detection) from exposure to the light source (e.g., the lamps). Thus, the service station 800, via the rotation device 508, rotated the spit roller 502 in the illustrated example clockwise 180° until the spit roller 502 stopped (e.g., hard stopped) against the rib 712 of the front coupler 510. The spit surface 504 and the vacuum slot 506 face down.

The opening 716 is shielded from the oncoming heat source or light source (e.g., oncoming lamps) via the shield 608 (see, e.g., FIG. 6). As the spit roller 502 rotated to the stop (e.g., hard stop), the spit roller 502 passed the scraper on the AR rail shield, removing accumulated dry fluid or ink, for example. Again, in this depicted example, the spit roller 502 is at a coupler stop via a coupler rib 712. Th front coupler rib 712 is in contact with the drive rib 702 of the spit roller 502, pinching the coupler 510 between the wiper housing 720 and the spit roller 502. The AR rail 520 remains pointed upwards and may become exposed by heat or light (e.g., IR light) when the heater-spreader carriage returns to the servicing side (right) of the printer. However, the service station 800, via the rotation device 508, may further rotate the spit roller 502 (e.g., counterclockwise) to such that the AR rail 520 is protected from the light source.

Indeed, the service modules 700 and 800 may be placed in an arbitrary position with the drop-detector carriage in its garage, for example. The rotation device 508 may be in a closed operating position such as with the AR rail 520 stopped against the wiper housing 720. Thus, the position of the heater spreader carriage may not be relevant. For example, the spit roller 502 may be rotated (e.g., counter-clockwise 210°) to take up the lost motion between the two drive ribs 702 and 712, and then the spit roller 502 rotates additionally (e.g., another 140°) with the AR rail 520 in tow until the AR rail 520 hits, for example, stop on the wiper housing 720. The surface 504 and the vacuum opening 506 may be pointed downwards and, therefore, generally shielded from the light source or lamps if in the neighborhood

In this arbitrary mode or similar arbitrary modes of the service station 700, 800 with the drop-detector carriage 512 not in use and in a garage, the spit roller 502 may be at coupler stop. Indeed, the coupler rib 712 may be in contact with the drive rib 702, pinching the coupler 510 (FIGS. 5 and 6) between the wiper housing 720 and the spit roller 502. Again, the AR Rail 520 may be protected from the light source or lamps. Also, the opening 716 may be closed. This may be a nominal operating position for the rotation device when the service station 700, 800 is idle. Such may prevent or reduce occurrence of components and powder falling into the servicing area. During 3D print jobs, the rotation device 508 may be in this nominal operating position to prevent or reduce powder or aerosol accumulation in the service station.

As mentioned above for some examples, the spit roller has at least three positions: (a) sense enabled, (b) sense disabled, and (c) sense disabled and isolated. Further, the rotational device may have at least two operating positions: (1) drop-detection carriage enabled and (2) drop-detection carriage disabled. See FIGS. 5-8A and the associated text in the description above. The (a) drop-detection carriage enabled can have or be associated with two roller positions (a) sense enabled and (b) sense disabled. The (2) drop-detection carriage disabled may correspond with the roller position (c) sense disabled and isolated.

Table 1 is a particular example of a rotation device state summary. The first column is the spit roller rotation in degrees. The second column is a state of the rotation device. The third column is the drop detection opening. The fourth column is a state of the drop-detector sensor carriage. The fifth column is a state of the drop detection. Lastly, the sixth column is an orientation of the spit-roller vacuum slot.

TABLE 1
Rotation Device State Summary.

| Roller | Rotation | Detection | Carriage | Detection | Slot |
|---|---|---|---|---|---|
| 0 | Full Stop | Open | Enabled | Not Ready | Down |
| 180 | Disengaged | Open | Enabled | Ready | Up |
| 210 | Start Engage | Open | Disabled | Not Ready | Up |
| 350 | Full Stop | Closed | Disabled | Not Ready | Down |

In this particular example of Table 1, with the drop detection opening closed, the service station may have increased protection from powder intrusion and from exposure to an energy-source (e.g., lamp) of the printer. For the drop-detector sensor carriage enabled, the drop detector sensor may be moved. For the drop-detection state as ready, the spit roller may be ready to receive spit fluid for drop detection. Lastly, for the orientation of the vacuum slot as down, the spit roller may be oriented to prevent or reduce energy-source (e.g., lamp) exposure to the drop-detection area.

FIG. 8A is a service station 800A which may be the service station 800 of FIG. 8 but depicted as operating in a third position or arbitrary position. In this example, the vacuum slot 506 of the spit roller 502 is facing down. Again, the vacuum slot 502 is defined or partially defined by at least portions 702 and 704.

In the illustrated example of this position (e.g., physical position of internal components, operating position, mode or state, and so on) of the service station 800A, the shield 608 is positioned or placed to block, partially block, or obstruct the opening 716 (see also FIG. 7). Indeed, the couplers (front and rear) 710 each having a rib 712 are rotated as compared to with operating state and positions of the service station 800 of FIG. 8.

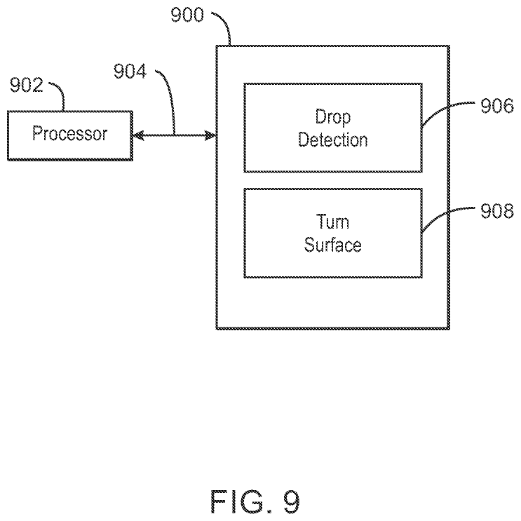

FIG. 9 is a block diagram of a computer-readable medium 900 that may contain code to execute the operation of a rotation device in a printer service to position a spit surface and other components. The medium may be a non-transitory computer-readable medium 900 that stores code that can be accessed by a processor 902 such as via a bus 904. For example, the computer-readable medium 900 may be a volatile or non-volatile data storage device. The medium 900 may also be a logic unit, such as an application-specific integrated circuit (ASIC), a field-programmable gate array (FPGA), or an arrangement of logic gates implemented in one or more integrated circuits. The medium 900 may store code (e.g., instructions, logic, etc.) executable to facilitate the techniques described herein. For example, drop detection code 706 may facilitate drop detection of print nozzles by the service station. Further, turn surface code may direct turning of a spit surface employed in the drop detection.

An example of a non-transitory, computer readable medium for a printer incudes machine-readable instructions, that when executed, direct a processor to turn, via a rotation device of a service station of the printer, a spit surface away from a heat source of the printer in response to movement of the heat source toward the service station, wherein the spit surface to receive spit fluid from nozzles of the printer during drop detection by the service station. Further, the instructions when executed may direct the processor to operate a vacuum system to remove the spit fluid from the spit surface via an opening of the surface. Also, the instructions when executed may direct the processor to position, via the rotation device, a shield to at least partially isolate a drop-detection area of the service station. The printer may be a 3D printer to print a 3D object. A spit roller of the printer may include the spit surface, and wherein to turn the surface involves to rotate the spit roller via the rotation device to turn the surface away from the heat source (e.g., light source).

While the present techniques may be susceptible to various modifications and alternative forms, the examples discussed above have been shown by way of example. It is to be understood that the technique is not intended to be limited to the particular examples disclosed herein. Indeed, the present techniques include alternatives, modifications, and equivalents falling within the true spirit and scope of the appended claims.

What is claimed is:

1. A method of operating a printer, comprising:
ejecting fluid through nozzles of the printer to a surface of a service station of the printer to perform drop detection of the nozzles via the service station;
performing the drop detection; and
turning the surface via a rotation device of the service station.

2. The method of claim 1, wherein turning the surface comprises turning, via the rotation device, the surface away from a heat source of the printer in response to movement of the heat source toward the service station.

3. The method of claim 2, comprising removing the fluid from the surface via an opening on the surface and via a vacuum system, wherein movement of the heat source toward the service station comprises movement of a powder spreader toward the service station, and wherein turning the surface away from the heat source comprises turning the surface away from airborne powder.

4. The method of claim 2, wherein a spit roller of the printer comprises the surface, and wherein turning the surface comprises rotating the spit roller via the rotation device to turn the surface away from the heat source.

5. The method of claim 1, comprising printing an object via the nozzles, wherein the rotation device comprises a motor, and wherein the rotation device to position a shield to at least partially isolate a drop-detection area of the service station.

6. The method of claim 1, wherein the nozzles comprise print nozzles disposed on a print bar, wherein the printer comprises a three-dimensional (3D), wherein the drop detection for quality assurance of 3D objects printed by the 3D printer, and wherein the drop detection is binary in determining a nozzle functions or does not function.

7. A printer comprising:
print nozzles; and
a service station comprising:
a surface positionable in a first position to receive spit fluid ejected from the print nozzles for drop detection;
a drop detector to sense the spit fluid ejected from the print nozzles to the surface in the first position; and
a rotation device to turn the surface from the first position to a second position in which the service station does not perform the drop detection.

8. The printer of claim 7, comprising a vacuum system to facilitate removal of the spit fluid from the surface via an opening of the surface, wherein the rotation device comprises a motor.

9. The printer of claim 7, wherein the service station comprises a spit roller comprising the surface, and wherein the rotation device to turn the surface to the second position comprises the rotation device to rotate the spit roller.

10. The printer of claim 7, comprising:
a print bar comprising the print nozzles to eject fluid to print an object; and
an energy source to apply energy to the fluid to print the object, wherein the rotation device to turn the surface to the second position away from the energy source.

11. The printer of claim 10, comprising a shield to be position via the rotation device to at least partially isolate a drop-detection area of the service station, wherein the energy source comprises a heat source or a light source, or both, and wherein the energy comprises heat or light, or both.

12. The printer of claim 8, comprising:
a print bar comprising the print nozzles to eject fluid onto material comprising powder to print an object from the material, wherein the printer comprises a three-dimensional (3D) printer, and wherein the object comprises a 3D object; and
an energy source to apply energy to the fluid on the material to print the 3D object, wherein the rotation device to turn the surface to the second position away from the energy source and away from airborne powder in response to movement of the energy source toward the service station.

13. A non-transitory, computer readable medium comprising machine-readable instructions for a printer, the instructions, when executed, direct a processor to turn, via a rotation device of a service station of the printer, a spit surface away from a heat source of the printer in response to movement of the heat source toward the service station, wherein the spit surface to receive spit fluid from nozzles of the printer during drop detection by the service station.

14. The non-transitory, computer readable medium of claim 13, wherein the instructions when executed direct the processor to:
operate a vacuum system of the printer to remove the spit fluid from the spit surface via an opening of the surface, wherein the rotation device comprises a motor; and
position, via the rotation device, a shield to at least partially isolate a drop-detection area of the service station.

15. The non-transitory, computer readable medium of claim 13, wherein the printer comprises a 3D printer to print a 3D object, wherein a spit roller of the printer comprises the spit surface, and wherein to turn the surface comprises to rotate the spit roller via the rotation device to turn the surface away from the heat source.
